(19) United States
(12) Patent Application Publication
(10) Pub. No.: US 2014/0374258 A1
(43) Pub. Date: Dec. 25, 2014

(54) POLYPHASE ALTERNATING CURRENT BI-IONIC PROPULSION SYSTEM FOR DESALINATION AND MARINE TRANSPORTATION

(71) Applicant: Monarch Power Corp., Scottsdale, AZ (US)

(72) Inventor: Joseph Y. Hui, Fountain Hills, AZ (US)

(21) Appl. No.: 14/309,589

(22) Filed: Jun. 19, 2014

Related U.S. Application Data
(60) Provisional application No. 61/838,098, filed on Jun. 21, 2013.

(51) Int. Cl. C02F 1/46

(52) U.S. Cl. CPC C02F 1/4604
USPC 204/554; 204/660; 204/663

(57) ABSTRACT

A system and method of using a traveling electric wave generated by means of intertwined helically wound electrodes powered by a polyphase alternating current, such that the traveling electric wave attracts both anions and cations in alternating bands of anions and cations, providing an electromotive force for these ions along the direction of travel of the electric wave, thus moving a concentrated ionic flow for the purpose of propulsion or removal of ions from a fluid.

### CLAIM OF PRIORITY

This application claims priority of U.S. Provisional Patent Application Ser. No. 61/838,098 entitled WATER DESALINATION BY AN ELECTROMOTIVE APPARATUS filed Jun. 21, 2013, the teachings of which are included herein in their entirety.

### BACKGROUND

Purification of water with low or medium salt content can have a huge impact on human and agricultural consumption of water. An apparatus that removes dissolved salt from water with relatively low energy, and being of small size could have a big impact for farming and small communities without the need for large and energy intensive desalination plants.

The traditional means of desalination includes multistage flash distillation, reverse osmosis, or electric dialysis. A large amount of energy is required to boil water, to force pure water through osmotic membranes, or push ions through dialysis membranes permeable to either positive or negative ions.

Most desalination plants use waste heat from a coal, oil, or natural gas fired power plant to evaporate seawater. This is done often in stages, whereby the steam generated in an earlier stage is condensed in a container of the next stage with a lower pressure, with the latent heat of condensation used to evaporate seawater at a lower temperature due to lower pressure and salinity. Thus, the waste heat is used successively to evaporate seawater of decreasing salinity and pressure with lower temperature of evaporation. This method achieves a low cost of desalination and in large volume, but is only achievable at a large scale with an abundant supply of waste heat. Multi-stage desalination cannot be done locally and may require a water distribution method to bring the desalinated water to a scattered population.

A rapidly emerging method for industrial desalination is the use of reverse osmosis. Natural osmosis occurs across a membrane porous only to the solvent but not the solute. Solvent flows from one side of the membrane with a lower concentration of solute to the other side with a higher concentration of the solute. Reverse osmosis reverses the direction of flow of the solvent by means of applying a high pressure to the side with a higher concentration of the solute. A high pressure in excess of 10 atmospheres may have to be applied to desalinate brackish water, with seawater requiring more than 20 atmospheres of pressure for effective desalination. Reverse osmosis requires a large amount of electricity to drive high pressure water pumps. Very often the porous membrane can be fouled by biological or chemical pollutants. Pre-filtering is often needed to remove harmful pollutants. Post-processing adds needed chemicals to balance the taste and acidity of the water purified by reverse osmosis.

A third method of desalination uses the process of electro-dialysis. The process is derived from electrolysis, with the addition of membranes porous to ions next to the electrodes. The cations, for example, the sodium ions of positive charge can pass through a porous membrane as the cations are attracted towards the negatively charged cathode. The anions, for example the chloride ions of negative charge, can pass through another porous membrane as the anions are attracted towards the positively charged anode. In this process, the salt water that flows into the chamber has both anions and cations removed and flows out of the other end of the chamber relatively pure.

Electro-dialysis uses Direct Current (DC) to remove ions. At the cathode side, sodium hydroxide (in the ionic form of Na+ and OH−) is generated. At the anode side, chlorine gas in a dissolved form is generated. These noxious chemicals are delivered to a recombination tank to regenerate the innocuous NaCl salt. Thus, the electrolysis and resulting recombination not only generate undesirable chemicals but also waste energy as the recombination is exothermic.

### SUMMARY

A system and method of using a traveling electric wave generated by means of helical electrodes powered by a polyphase alternating current, such that the traveling electric wave attracts both anions and cations in alternating bands of anions and cations, providing an electromotive force for these ions along the direction of travel of the electric wave, thus moving a concentrated ionic flow for the purpose of propulsion or removal of ions from a fluid.

In one exemplary embodiment, an apparatus is comprised of an upper tank of diluted electrolyte and a lower tank of concentrated electrolyte, which are connected by tubes with intertwined electrodes powered by a polyphase alternating current of controlled frequency, voltage, and current. These tubes generate an electromotive force to drive alternate bands of anions and cations for the purpose of ion removal from the upper tank and ion concentration in the lower tank, thus performing the function of desalination of water.

### BRIEF DESCRIPTION OF THE DRAWINGS

For a more complete understanding of the present disclosure and its advantages, reference is now made to the following description taken in conjunction with the accompanying drawings, in which like reference numerals represent like parts, wherein:

FIG. 1 shows a front slanted view of the entire device for desalination;

FIG. 2 shows a front slanted view of the device exposing components at various levels;

FIG. 3 shows a front cross section view of the desalination tube;

FIG. 4 shows the electric circuit for controlling frequency, current, and voltage;

FIG. 5 shows a front view of the apparatus for PACBIPS;

FIG. 6 shows a front cross section view of the apparatus for PACBIPS; and

FIG. 7 shows electric field distribution along the apparatus for PACBIPS.

### DETAILED DESCRIPTION

This disclosure provides a new method and apparatus to desalinate water by means of a Polyphase Alternate Current Bi-Ionic Propulsion System (PACBIPS) which is used to create a traveling wave, whereby the positive crest of the wave attracts anions and the negative trough of the wave attracts cations. As the traveling wave moves forward, these ions are propelled away and the salty water is deionized. The propelled ions may also drive the motion of seawater by means of viscosity, providing a motive reaction to move a marine vehicle.

The apparatus removes dissolved salt from water with relatively low energy, and the small size of the apparatus could have a large impact on farms and small communities without the need for large and energy intensive desalination plants.

Energy used is directly proportional to the amount of salt that needs to be removed. The method is therefore suitable for lower salt content removal such as brackish water. The apparatus uses only electricity, for example from solar panels. The apparatus does not need pressure, heat, dialysis, or semi-permeable membranes which require significant capital investment.

This disclosure does not use heat, pressure, or chemical reactions as prior art methods do. It uses less energy by using electrostatic forces to directly de-ionize water. It also avoids chemical processes that occur at the electrodes and in the recombination reservoir of electro-dialysis.

Instead of causing ionic motion through a direct current (DC) induced electric field in an electrolyte, this disclosure uses polyphase alternating current (AC) instead to create a conveyor belt of alternating strips of cations and anions. The principle is very similar to a linear induction electric motor, although no use is made of an induced magnetic field to generate a magnetic motive force. Instead, the polyphase AC electrodes are used to generate a traveling wave.

A simple analogy is the use of the ocean waves for surfing. Ocean waves are traveling waves, it is not that the seawater is travelling towards the shore, but rather that the up and down motion of the seawater brings about a motion of the wave in a horizontal direction towards the shore. A surfer takes advantage of the slope of the front surface of the travelling wave, using its gravitational potential in the wave crest to propel the surfer towards the shore.

In this disclosure, electric field forces are used instead of gravitational field forces for propulsion. Instead of gravitational forces driving the surfer forward, electromotive forces drive both positive and negative electric ions forward. Cations are attracted to the crest of the electric field wave, and anions are attracted to the trough of the electric field wave. Both types of ions travel in the same direction of the traveling wave.

The changing electric fields are generated by a polyphase AC power source driving a set of electrodes. The electric fields drive the cations towards the lower electric potential and the anions towards the higher electric potential.

The forward motion of the traveling wave is explained as follows. Suppose there are N phases of an AC power source. The number of phases can be N=2 or higher. The higher the number of phases N, the smoother the travelling wave will be. Nevertheless, N=3 is preferred because of ubiquitous industrial three phase power sources at a frequency of f=60 Hertz.

These electrodes could be discrete, for example as rings around an insulating tube. There are N electrodes with each successive electrode carrying the successive phase of the N phase AC power source. The i-th electrode, for i ranging from 1 to N, is tied to the i-th phase of the N-phase AC power source, and therefore carries the voltage

$${V}_{i} ( t ) = A cos ( 2 π ( f t - \frac{i - 1}{N} ) ) .$$

Consecutive electrodes are separated at a distance of d/N. The i-th electrode is placed at the location

$${x}_{i} = \frac{( i - 1 ) d}{N} .$$

From x=d, the set of electrodes repeats from 1 to N all over again. In other words, the i-th electrode located at the position xᵢ recurs at the positions

$${x}_{N + i} = \frac{( N + i - 1 ) d}{N} , {x}_{2 N + i} = \frac{( 2 N + i - 1 ) d}{N} , … ,$$

etc. Each recurring i-th electrode carries the same voltage

$${V}_{i} ( t ) = A cos ( 2 π ( f t - \frac{i - 1}{N} ) ) .$$

The traveling wave has a wavelength of λ=d and a wave velocity v=fd. The traveling wave has a voltage that depends on both space and time, i.e.

$$V ( x , t ) = A cos ( 2 π ( f t - \frac{x}{d} ) ) .$$

The traveling wave velocity v is derived by looking at the location of a crest with a phase of 0. Therefore

$$f t - \frac{x}{d} = 0 ,$$

giving x=fdt=vt and the velocity of the traveling wave is v=fd.

The voltage of the electrodes is the discrete sampling of voltage the traveling wave

$$V ( x , t ) = A cos ( 2 π ( f t - \frac{x}{d} ) ) .$$

This gives the sampled voltage of each electrode as

$$V ( x = \frac{( i - 1 ) d}{N} , t ) = A cos ( 2 π ( f t - \frac{( i - 1 )}{N} ) ) .$$

Take the simplest case of N=2, which gives V₁(t)=−V₂(t) etc. This alternating signage gives an alternating electric field from one electrode to the next. The cations, which are positively charged, are accelerated in between two electrodes with electric field going in one direction; whereas the anions are accelerated in the same direction in the next pair of electrodes as the electric field is reversed.

If the velocity of the ions matches that of the velocity of the traveling wave v=fd, the electric field reversal of the next pair of electrode will occur just in time for the ions to travel further down.

This works similarly for other larger N, and in the limit of very large N, the piecewise linear traveling wave now resembles the continuous wave. The cations are carried by the trough (negative voltage) of the traveling wave, whereas the anions are carried by the crest (positive voltage) of the traveling wave.

The flow of the anions and cations in alternating bands becomes a motive force for the electrolyte by means of the fluid's viscosity. The flow of ions is expected to be self-priming similar to the self-priming of the Tesla three-phase induction motor. Another priming method is seen from the equation for the velocity of the traveling wave v=fd. The motion of the electrolyte is self-primed by starting with a low value of f at the beginning or a small separation d.

Instead of discrete and equally spaced electrodes, one configuration to realize a traveling wave is through the use of intertwining helical electrodes. Each electrode turns 360 degrees around the x-axis while it traverses a distance of wavelength d along the x-axis. The initial angular position of the i-th electrode around the x-axis is

$$\frac{i - 1}{N} \times 360 ° ,$$

which is the same angle as the i-th phase of the polyphase AC power source.

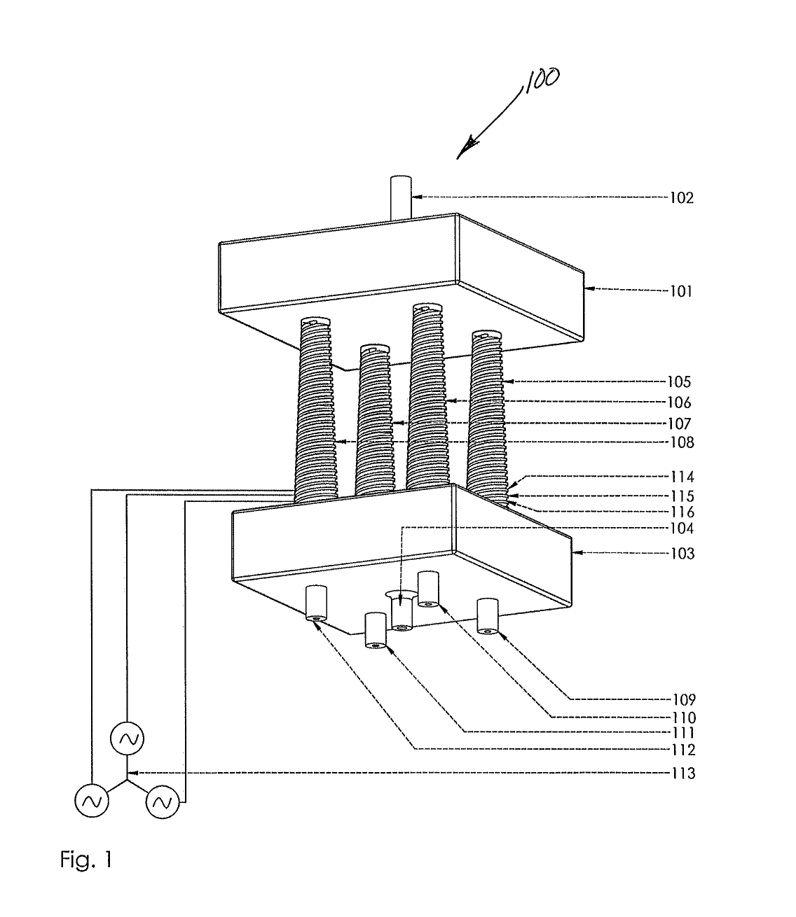

An external view of a desalination apparatus 100 is shown in FIG. 1. An upper tank 101, which holds desalinated water, has an outlet 102. A lower tank 103, which holds concentrated electrolytic solution, has an outlet 104. As shown, four desalination tubes 105, 106, 107, 108 provide an electromotive force to move ions from the upper tank 101 to the lower tank 103. Liquid removed from 102, 104 is replenished with fresh electrolytic solution into the center of tubes 105, 106, 107, 108 through inlets 109, 110, 111, 112, respectively. A three phase power source 113 provides the electromotive force for moving ions. Each phase of source 113 drives each of the intertwined electrodes 114, 115, 116.

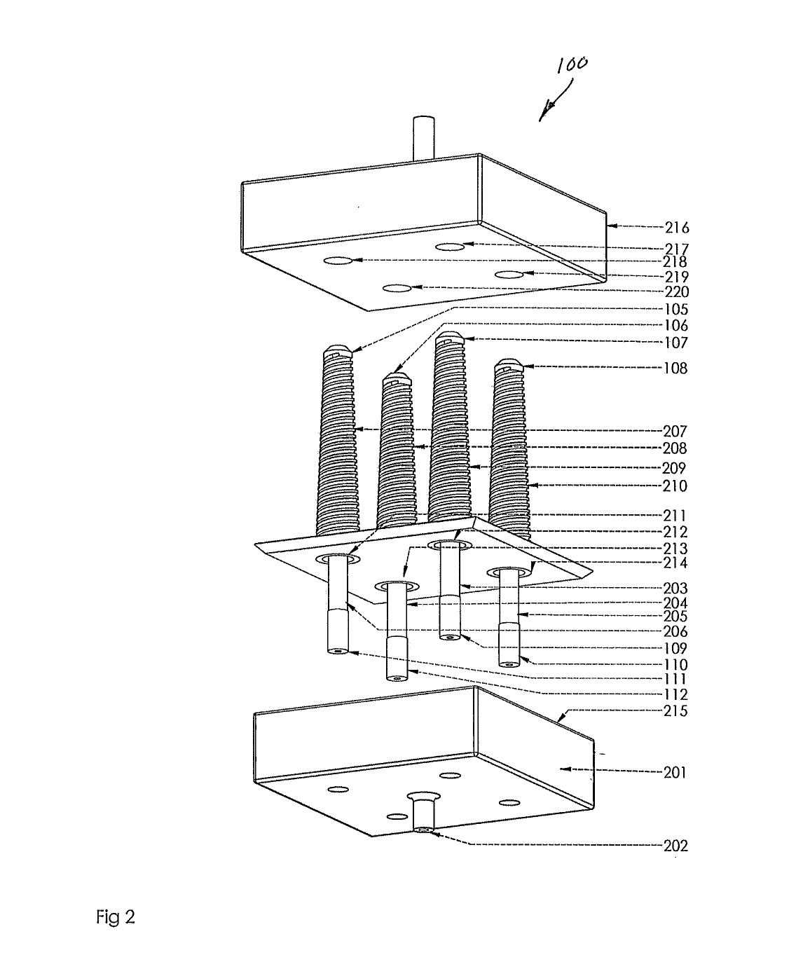

An exploded transparent view of the desalination apparatus 100 is shown in FIG. 2. The lower tank comprises a vessel for holding strong electrolytic solution 201 with exit hole 202. The fresh electrolytic solution inlets 109, 110, 111, 112 opens into tapering tubes 203, 204, 205, 206 respectively, so that fresh electrolytic solution is introduced into the middle and inside portion of the desalination tubes 105, 106, 107, 108, respectively.

The desalination tube components are shown in the middle of FIG. 2. The tapering tubes 203, 204, 205, 206 are inserted into exit end of the desalination tubes 207, 208, 209, 210 through the holes 211, 212, 213, 214. The middle assembly of components connects to the lower assembly at location 215.

The intertwined electrodes 114, 115, 116 provide a downward electromotive force for ions from the fresh electrolyte coming upward into the middle of the desalination tubes. The desalinated water flows into the upper tank 216 from the desalination tubes 207, 208, 209, 210 through the holes 217, 218, 219, 220.

The desalination tubes also tend to draw any remaining ions from the upper tank 216, creating an increasing concentration gradient of salinity towards the bottom of the tank. Relatively purified water can be extracted from the top for consumption. Depending on the purity needed, the extracted fluid may be further purified by similar apparatuses in stages. The extraction of fluid in either the upper or lower tank draws in fresh fluid to be desalinated.

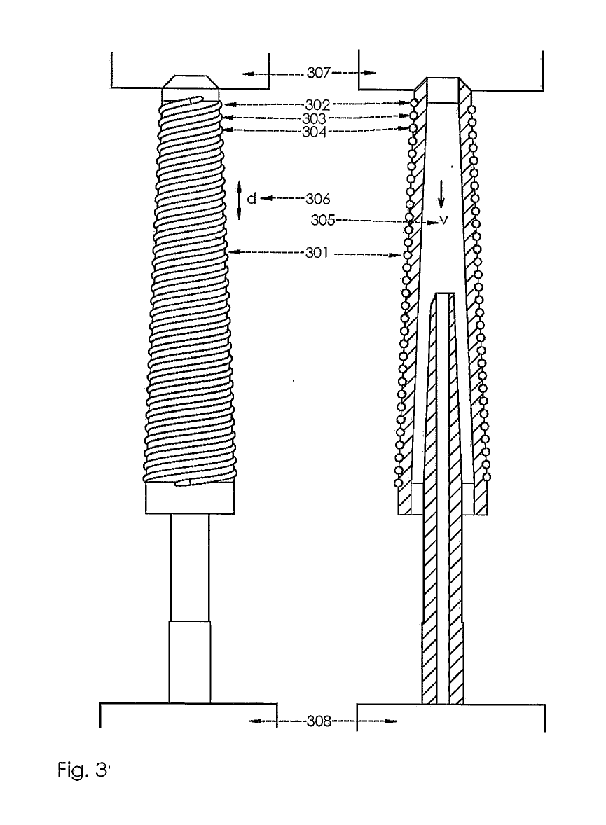

FIG. 3 shows a solid view on the left and a cross-sectional view on the right of the same apparatus for a single desalination tube, illustrating the electrical wiring and structure. Fresh electrolyte 301 enters the desalination tube, flowing upward. The three-phase intertwined helical electrodes 302, 303, 304 are shown.

As the electrodes are driven by a polyphase alternating current (PAC), the ions are driven by the traveling electric wave down the tube with a velocity v 305 such that v=fd, where f is the frequency of the PAC, and d is the wavelength of the traveling wave, which is also the distance d 306 for the electrode to make one complete turn.

In this apparatus, ions are driven from the upper tank to the lower tank, creating relatively ion-free solution 307 and concentrated ion solution 308 in the upper tank and lower tank respectively.

The same electromotive force could be used for the purpose of marine propulsion for a high velocity of v=fd. In this case, both f and d would be much larger so variable control of the velocity would be needed. The control of the velocity is similar to that for electric cars with a variable f (from a full stop, the accelerator generates a polyphase AC current of gradually increasing frequency, usually of a constant voltage but with a very large initial current).

The frequency of the polyphase AC power source can be controlled by a DC-to-AC inverter based on pulse width modulation (PWM). The DC power can come from either a battery or solar power source. The amount of current I can be controlled with an inductor placed in series with each of the electrodes, and is given by the generalized Ohm's law of I=V/Z where Z=j2πfL+R is the complex impedance that depends on the frequency f, the inductance L, and resistance R of the circuit.

A higher voltage for the PAC may accelerate ions faster, enabling self-priming of the fluid from a zero flow velocity. In steady state, the velocity of fluid flow approaches the velocity v=fd of the traveling wave. Thus, the use of higher voltage more effectively transfers the electric forces onto ions, which then drive the surrounding water molecules by means of viscosity. A figure of merit is that a static electric field of 1V/cm tends to move ions in a stationary fluid at a terminal velocity on the order of 1 mm per second. An AC electric field of 60 Hertz frequency would travel about 20 microns within a 60 Hz cycle of less than 20 milliseconds ( 1/60 seconds=16.7 milliseconds). Thus, the electrode distance d for circuit with 120V for each of the three-phase AC power source may be on the order of millimeters for effective self-priming.

For marine locomotion, the frequency may range from less than 10 Hertz to KHz for accelerating the fluid flow from zero velocity to say 36 km/hour (24 mph or 10 meters per second). Thus, a 1 KHz frequency and a distance d=1 cm gives a fluid velocity of v=fd=10 meters per second.

For desalination, a large current is advantageous for ion removal. Seawater typically has 35 grams of salt dissolved in 1 liter of water, or 3.5% by weight. One mole (6.022×10²³ molecules) of salt comprises 35.5 grams for the chloride ion and 23 grams for the sodium ion. Thus, one liter of seawater therefore has slightly more than half a mole of salt. Therefore, desalinating one liter of seawater may use 50,000 Coulombs of electric charge.

This explains why electro-dialysis is energy inefficient for desalination. Even at a low DC voltage of 1V in a cubic electrolytic cell with a dimension of 1 cm per side, 50,000 Coulombs is required. This equates to an energy of 50,000 Joules to desalinate 1 liter of water. Much of that energy is wasted in the production of toxic sodium hydroxide and chlorine gas, which must be recombined to form NaCl salt again in the recombination tank.

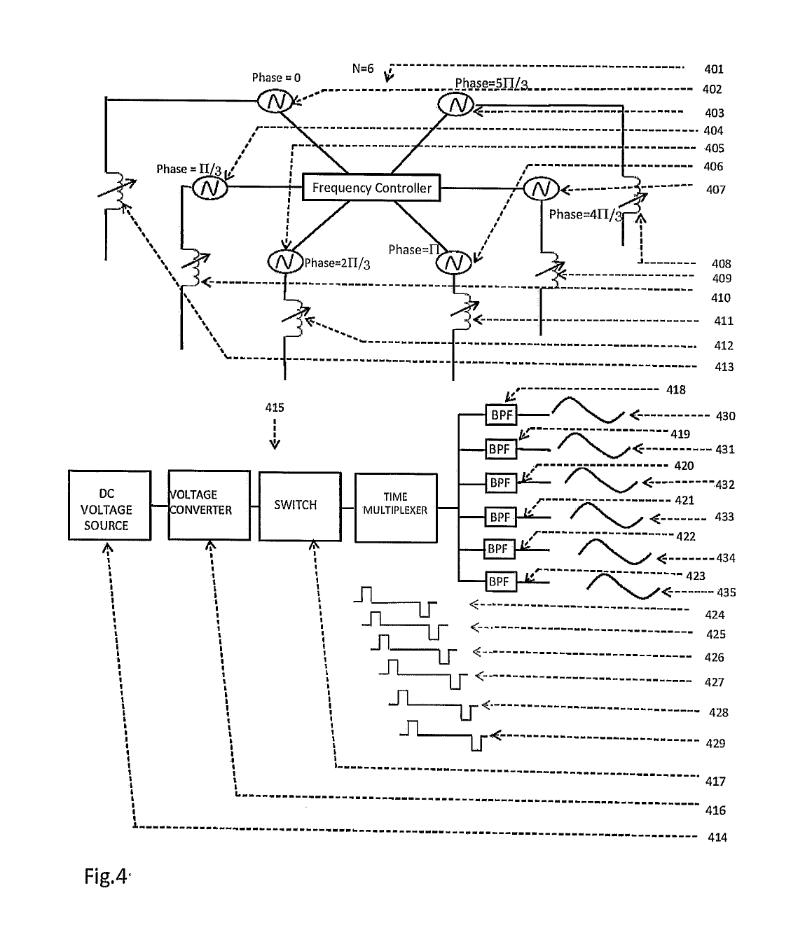

The electric circuit of a six-phase version of a DC-AC inverter is shown in FIG. 4. The six-phase power source 401 consists of phases 402, 403, 404, 405, 406, 407. To control current flow in the electrodes, inductors 408, 409, 410, 411, 412, 413 are used on each of the six-phase terminals 402, 403, 404, 405, 406, 407 respectively. According to Ohm's law I=V/Z where Z=j2πfL+R, where Z is the complex impedance dependent on the inductance L and resistance R present in the inductor and the electrodes. A resistor could be used instead of the inductor to regulate the current I, but this is less desirable as ohmic resistance would waste energy by turning a significant amount of the electricity into waste heat.

The PAC power could also be generated instead by a solar photovoltaic or a battery power source 414. This local alternative power source could facilitate water desalination and marine propulsion. Using PV cells with battery storage to drive a marine vehicle by the PAC method enables very efficient propulsion of marine vehicle, while the same propulsion system can also be used to desalinate seawater for human consumption.

The use of solar PV panels and/or chemical batteries to supply a constant DC power requires a DC-to-polyphase-AC inverter 415. The DC power source, properly voltage adjusted by a voltage converter 416 is gated by switch 417 into time multiplexed current in N equals 6 circuits 418, 419, 420, 421, 422, 423. This method is known as Pulse Width Modulation (PWM).

The multiplexing acts in 12 time slots within a frame of duration 1/f seconds. In the first time slot, a positive pulse of current A is sent into circuit 418, and in the seventh time slot a negative pulse of current, A is sent into the same circuit as illustrated in the current chart 424. Likewise, the current chart 425 for circuit 419 has positive current flow in the second time slot and negative current flow in the eight time slot. Similarly, the current chart 426 for circuit 420 has positive current flow in the third time slot and negative current flow in the ninth time slot. The current chart 427 for circuit 421 has positive current flow in the fourth time slot and negative current flow in the tenth time slot. The current chart 428 for circuit 422 has positive current flow in the fifth time slot and negative current flow in the eleventh time slot. The current chart 429 for circuit 423 has positive current flow in the sixth time slot and negative current flow in the twelfth time slot.

Each of these periodic positive and negative current pulses is filtered by a narrow band pass filter 418, 419, 420,421, 422, 423 with center frequency f. The output of the filter is an alternating current 430,431,432,433,434, 435 of a staggered phase determined by the timing of the pulses.

For the purpose of priming, the frequency f increases gradually from zero to the desirable frequency as dictated by the velocity requirement v=fd. The frequency is controlled simply by the duty cycle of repetition for the pair of pulses for each circuit. Controlling the frequency f and the current I changes the speed and power output of PACBIPS for marine propulsion.

This method of generating PAC is simple for any polyphase number N>2, which could be large (for example N=6) for marine propulsion purposes.

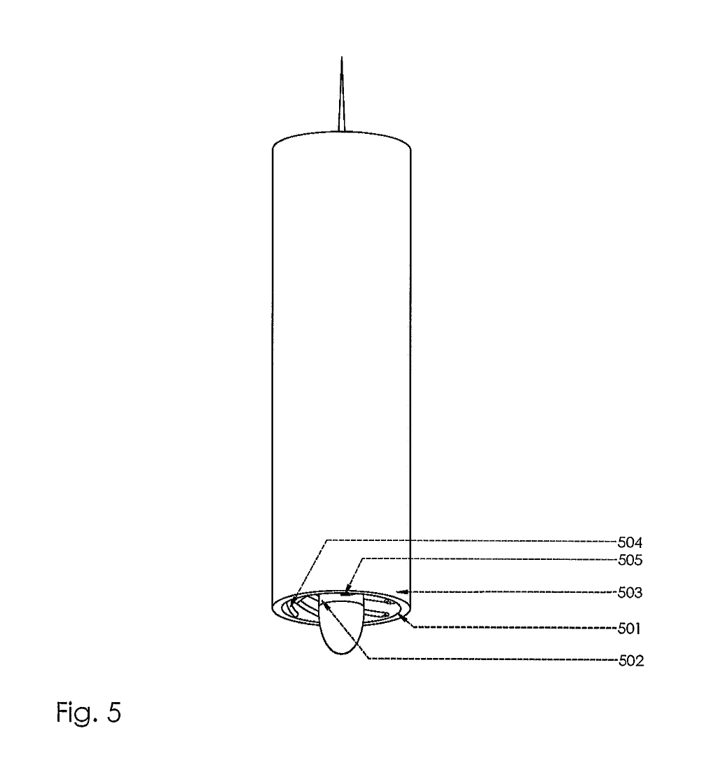

A design of a PACBIPS for marine transportation is shown in FIG. 5. The PACBIPS comprises a metallic or fiber composite tube 501 for mechanical support.

In the center of the tube is a flow regulator 502 designed to increase the flow velocity towards the end of the tube 503.

Two sets of intertwining electrodes 504, 505, adjacent to the inside of the tube 501 and to the outside of the regulator 502, respectively. These electrodes work together to accelerate seawater towards the end of the tube 503.

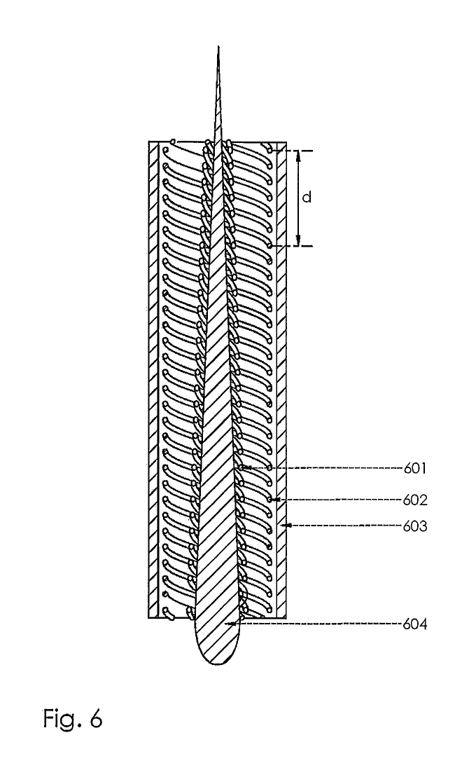

FIG. 6 shows a cross section view of the PACBIPS to illustrate the electrical system. The two sets of intertwining electrodes 601, 602 are adjacent to the tube 603 and regulator 604. These electrodes may have an uneven spacing, for example with the distance between successive turns of an electrode increasing down the length of the tube.

For a larger motive force on the ions, a higher voltage is recommended so the voltage difference between successive electrodes remains significantly large.

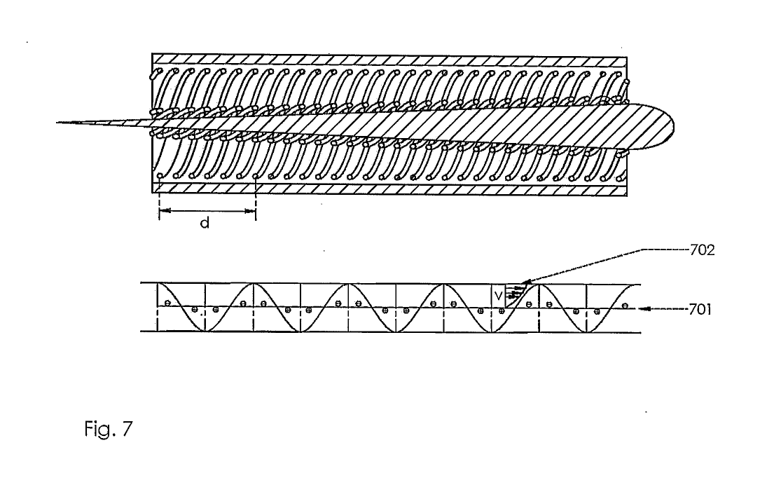

FIG. 7 shows the electric field chart 701 of the traveling wave as well as resulting travel velocity v 702 down the PACBIPS. To produce thrust against water and wind resistance, the ejected water velocity should be multiples of the vehicle velocity.

Modifications, additions, or omissions may be made to the systems, apparatuses, and methods described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. As used in this document, “each” refers to each member of a set or each member of a subset of a set. To aid the Patent Office, and any readers of any patent issued on this application in interpreting the claims appended hereto, applicants wish to note that they do not intend any of the appended claims or claim elements to invoke paragraph 6 of 35 U.S.C. Section 112 as it exists on the date of filing hereof unless the words “means for” or “step for” are explicitly used in the particular claim.

We claim:

1. A method of using an ion propulsion system, comprising:
generating a traveling electric wave using polyphase alternating current, such that the traveling electric wave attracts ions comprising both anions and cations in alternating bands of anions and cations; and
providing an electromotive force for the ions along a direction of travel of the traveling electric wave, thus moving a concentrated ionic flow of fluid to create ionic propulsion or removal of the ions from the fluid.

2. The method as specified in claim 1, comprising:
using an apparatus having intertwining electrodes each powered by a successive phase of the polyphase alternating current of controlled frequency, voltage, and current;
such that the electromotive force drives the alternating bands of the anions and the cations along the direction of travel of the traveling electric wave to create the ionic propulsion or removal of the ions from the fluid.

3. The method as specified in claim 1, comprising:
using an apparatus having an upper tank of diluted electrolyte and a lower tank of concentrated electrolyte, which are connected by tubes with intertwining electrodes each powered by a successive phase of the polyphase alternating current of controlled frequency, voltage, and current;
such that the tubes generate a downward said electromotive force to drive the alternating bands of the anions and the cations to create ion removal from the diluted electrolyte in the upper tank and ion concentration in the electrolyte in the lower tank, thus desalinating water.

4. The method as specified in claim 3, wherein a plurality of sets of the intertwining electrodes and a flow regulator constrict flow of the fluid along a length of the tubes to accelerate the fluid flow from the upper tank to the lower tank.

5. The method as specified in claim 2, wherein a distance between each turn for each of the intertwining electrodes changes with the number of turns made, and accelerates the flow of fluid along a length of the intertwining electrodes.

6. A system comprising:
a plurality of N helically intertwining electrodes forming a helix, with each said electrode completing a turn in a distance that is fixed or increasing as a number of turns made; and
an N-phase alternating current power source configured to power each of the electrodes with successive phases, configured to create a traveling electric wave along the helix of the electrodes at a velocity given by a product of a frequency of the N-phase alternating current and the distance of a single turn of one of the electrodes.

7. The system as specified in claim 6, further comprising:
a controller configured to:
provide frequency, voltage, and current control of the N-phase alternating current power source, with the frequency configured to be controlled by pulse width modulation of non-overlapping current for each phase of the N-phase alternating current power; and
use a narrowband band pass filter to create a sinusoidal wave of varying frequency.

8. The system as specified in claim 7, wherein the controller is configured to provide the current control of the N-phase alternating current power source by using a variable impedance comprising an inductor and a resistor.

9. The system as specified in claim 7, wherein the controller is configured to provide the voltage control using a voltage divider coupled between two variable impedance elements, or by means of an alternating current voltage transformer.

10. The system as specified in claim 6, wherein the system is configured to desalinate water.

11. The system as specified in claim 6, further comprising:
an apparatus having an upper tank of diluted electrolyte and a lower tank of concentrated electrolyte, wherein the intertwining electrodes have tubes connecting the upper tank to the lower tank, wherein the intertwining electrodes are each powered by a successive phase of the N-phase alternating current of controlled frequency, voltage, and current;
such that the tubes generate a downward electromotive force to drive alternating bands of anions and cations to create ion removal from the diluted electrolyte in the upper tank and ion concentration in the electrolyte in the lower tank, thus desalinating water.

12. The system as specified in claim 6, further comprising:
wherein the traveling electric wave is configured to attract ions comprising both anions and cations in alternating bands of anions and cations; and
a generator configured to provide an electromotive force for the ions along a direction of travel of the traveling electric wave, configured to move a concentrated ionic flow of fluid to create ionic propulsion or removal of the ions from the fluid.
